(19) United States
(12) Patent Application Publication
(10) Pub. No.: US 2006/0170541 A1
(43) Pub. Date: Aug. 3, 2006

(54) Smart portable detection apparatus and method

(76) Inventors: Gary S. Tompa, Belle Mead, NJ (US); Joseph D. Cuchiaro, Colorado Springs, CO (US)

Correspondence Address: DOCKET ADMINISTRATOR;LOWENSTEIN SANDLER PC, 65 LIVINGSTON AVENUE, ROSELAND, NJ, 07068, US

(21) Appl. No.: 10/774,972

(22) Filed: Feb. 9, 2004

Related U.S. Application Data
(60) Provisional application No. 60/445,861, filed on Feb. 9, 2003.

(51) Int. Cl. G08B 23/00

(52) U.S. Cl. 340/500; 340/521

(57) ABSTRACT

This invention relates to a smart portable detection apparatus and method that provides portable detection in a cost effective manner. The invention includes a portable computer communicatively connected to a detector. The detector transmits a signal to the portable computer when a detection is made by the detector, and the portable computer produces an alarm in response to the signal. The alarm, as well as the location of the detector, are transmitted via a communication device to a central command location, and the smart apparatus may accept external input to update situational awareness and accept commands.

### CROSS-REFERENCE TO RELATED APPLICATION

This application claims the benefit of U.S. Provisional Application No. 60/445,861, filed Feb. 9, 2003, the entire disclosure of which is hereby incorporated herein by reference. This patent application is also related to U.S. Patent Application entitled “Microelectronic Radiation Detector” by Gary Tompa and Joseph Cuchiaro filed concurrently herewith and incorporated herein by reference in its entirety.

### FIELD OF THE INVENTION

This invention relates to the field of portable detection devices. In particular, this invention relates to small and portable devices that include one or more various types of sensors, such as biological, chemical, radiological, user biometric, radio frequency, and other types of sensors.

### BACKGROUND OF THE INVENTION

In an increasingly unsettled world, the use of biological, chemical, or nuclear weapons has become a serious threat. Accordingly, a demand exists for a way to detect the use of such weapons portably and in a reliable and cost effective manner. For example, the Homeland Security Advanced Research Projects Agency (HSARPA) has released a Research Announcement (RA)(HSARPA RA 03-01) entitled “Detection Systems for Biological and Chemical Countermeasures.” The RA solicits responses in five Technical Topic Areas (TTAs), in which TTA-4 announces a need for a Lightweight Autonomous Chemical Identification system (LACIS). The LACIS would be a hand portable, automonous, detection system that will allow first responders to determine dangerous concentration of chemical warefare agents and toxic industrial chemicals.

Further, the Technical Support Working Group has identified the need for a pager style gamma (and optionally neutron) radiation detector that meets the developing ANSI N42.32-2003 standards; including identifying its location using the Global Positioning System (GPS) and reporting its status in real time.

### SUMMARY OF THE INVENTION

These problems are addressed and a technical solution achieved in the art by a smart portable detection apparatus and method that provides portable detection in a cost effective manner. The portable detection apparatus includes a portable computer communicatively connected to a detector, wherein the detector transmits a signal to the portable computer when a detection is made by the detector, and the portable computer produces an alarm or other response in response to the signal. The apparatus also includes a location device communicatively connected to the portable computer, and a communication device also communicatively connected to the portable computer. The detector comprises (a) a detector element that outputs an unprocessed signal, and (b) a digital signal processing device that converts the unprocessed signal from the detector element into a processed signal, wherein the processed signal is transmitted to the portable computer. The digital signal processing device outputs the detector signal and optionally a warning signal if the processed signal is above an adjustable or programmable threshold level, and the detector produces its own alarm in response to the warning signal or in response to general signal trends or other programmed factors. The alarm functions may be pre-programmed or modified in real time.

The detector may be selected from the group consisting of a radiation detector, a biometric sensor, a radio frequency sensor, a chemical detector, a situational imager, a weather device, and a biological detector or combination thereof, and may be a scintillator with photodiode detector, a photodiode detector, an SRAM radiation detector, an imaging device, a residual gas analyzer (“RGA”), an infrared (“IR”) spectral absorption instrument, weather sensor, or a solid state chemical sensor or combination thereof.

Exemplary portable computers include a personal digital assistant (“PDA”) or a laptop computer, and an exemplary location device is a Global Positioning System (“GPS”) device. The communication device may communicate via a cellular, Bluetooth, satellite, radio, infrared, WiFi, Universal Serial Bus, parallel, or serial connection.

The portable detection method includes generating a detection signal with a detector, transmitting the detection signal to a portable computer communicatively connected to the detector, comparing the detection signal to an adjustable threshold level, and producing an alarm signal with the portable computer if the detection signal exceeds the threshold level. Generating the detection signal comprises converting an unprocessed signal from a detection element into a processed signal with a digital signal processor, and outputting the processed signal as the detection signal. The method also includes recording a location of the detector with a location device communicatively connected to the portable computer, and transmitting the alarm signal and/or the location of the detector via a communication device communicatively connected to the portable computer.

### BRIEF DESCRIPTION OF THE DRAWINGS

A more complete understanding of this invention may be obtained from a consideration of this specification taken in conjunction with the drawings, in which:

FIG. 1 is a schematic view of an exemplary embodiment of the present invention.

FIG. 2 is a pictorial view of components that may be utilized to implement the exemplary embodiment of the present invention;

FIG. 3 illustrates several possible radiological detectors for use in the exemplary embodiment of the present invention;

FIGS. 4a and 4b show an example implementation of the exemplary embodiment; and

FIGS. 5 and 6 are graphs showing results from a test performed with the example implementation of the exemplary embodiment.

It is to be understood that the drawings are for the purpose of illustrating the concepts of the invention and are not necessarily to scale.

### DETAILED DESCRIPTIONS OF THE EXEMPLARY EMBODIMENT OF THE INVENTION

The present invention provides a smart, interactive platform for portable detection by integrating a detector with a portable computer and two-way communication capabilities, so that a user personally using the device has feedback, and information, such as detection results, notes, observations, and images, from the device can be transmitted to a remote location, such as a central command location. The device may also receive commands from the remote location, thereby providing significant operating flexibility. The device can also generate and update maps of terrain and hazards present and in what quantities. Such updated onboard information is valuable to the operator should the two-way communication system subsequently be disconnected.

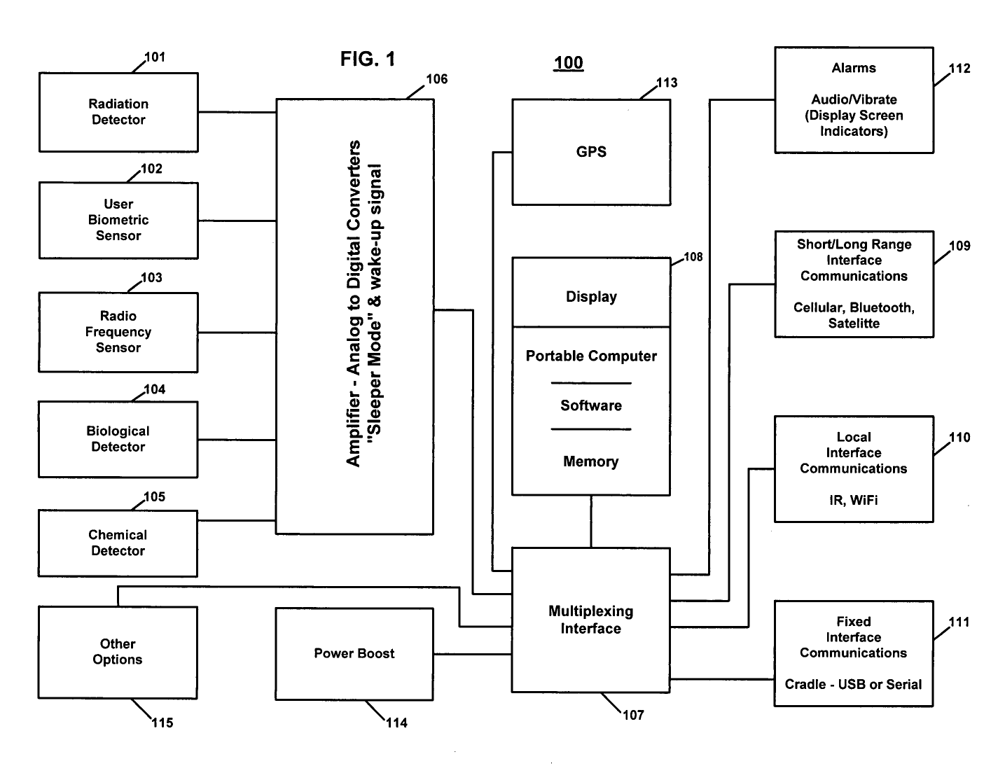

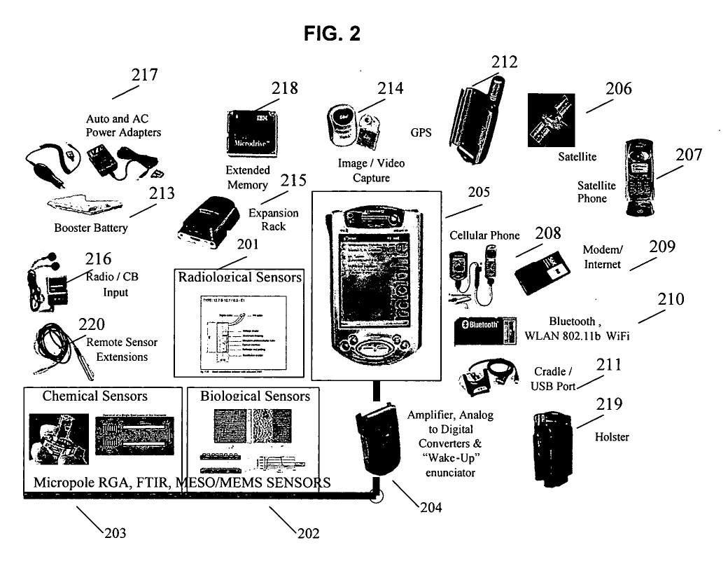

FIG. 1 is a schematic representation of the exemplary embodiment of the present invention, and FIG. 2 depicts components that may be utilized to implement the exemplary embodiment of the present invention. Referring to FIG. 1, the portable detector system 100 of the exemplary embodiment includes one or more detectors or sensors, such as radiation detector 101, user biometric sensor 102 (such as a heart-rate monitor), radio frequency (“RF”) sensor 103, biological detector 104, and chemical detector 105. Although several detectors are shown, one or more may be used depending upon requirements. And, although only radiation, user biometric, RF, chemical, and biological detectors are shown, other types of detectors may be used, such as a weather sensing instrument.

Also included in the system 100 are digital signal processing (“DSP”) components 106 which amplify the detection signals output from the detectors 101-105 and convert the analog detection signals into digital format, if necessary. (The SRAM radiation detector, discussed below, outputs its signal in a digital format, and therefore, no conversion is necessary.) The DSP 106 and the one or more detectors 101-105 may be included on the same printed circuit board (not shown), or similarly, a given DSP 106 could be incorporated into the one or more detectors 101-105. The digital signal from DSP 106 is output to an interface 107. Connected to the interface 107 is, among other things, a portable computer 108. An exemplary portable computer 108 is a personal digital assistant (“PDA”), as is known in the art, that may be modified to include more robust packaging to protect it from harsh environments. Portable computer 108 may also be other types of computers, such as a laptop computer, and the invention is not limited to any particular type of portable computer 108.

The interface 107 may be a stand-alone device, may be made part of the DSP 106, or may be incorporated into the portable computer 108. Also, although one interface 107 is shown in FIG. 1, one or more interfaces may be provided, such that one or more devices may be connected to one or more interfaces. The important aspect of the invention regarding the interface 107 is that the individual devices be able to communicate with each other and with the portable computer 108, and the present invention is not limited to any particular interface arrangement.

The digital signal from the DSP 106 is transmitted through the interface 107 to the portable computer 108. The DSP 106 also transmits “wake-up” and “sleep” signals to the portable computer 108. For example, the DSP 106 monitors the incoming detection signals from the detectors 101-105, and if the incoming signals are greater than a threshold value, the DSP 106 will issue a “wake-up” signal. The “wake-up” signal instructs the portable computer 108 to enter a robustly operating state. On the other hand, if the incoming signals are below a threshold value for a certain period of time, the DSP 106 will issue a “sleep” signal instructing the portable computer 108 to enter a “sleep mode” where non-essential components are shut down to conserve power.

Also connected to the interface 107 are communication devices 109, 110, and 111. The short/long range communication device 109 is used to transmit messages to another location and receive messages from another location, such as a central command location. The types of messages include detection results, detector location information from GPS device 113, discussed below, or commands and instructions for portable computer 108. The communication device 109 may use telephone, cellular, Bluetooth, satellite, radio (including military systems) or other wired or wireless communication means. Local interface communication device 110 is used to communicate between local components, such as between the portable computer 108 and the DSP 106. The communication device 110 may use infrared, 802.11 Wireless Fidelity (“WiFi”), or other wireless communication means. Fixed interface communication device 111 provides fixed, or wired communication, between the local components. The communication device 111 may use a Universal Serial Bus (“USB”), serial connection, parallel, Ethernet, or other wired connection types. Although multiple communication devices 109-111 are shown, one or more may be used. Further, although the communication devices 109-111 are shown outside the portable computer 108, they may be included in the portable computer 108, the multiplexing interface 107, or the DSP 106. The invention is not limited to the physical location of these devices, and the other devices shown in FIG. 1. It should also be noted that the means of communicating between components of this invention may take any of these or other forms, and the present invention is not limited to any particular communication means. For instance, communication between the DSP 106 and the interface 107 may be wireless or wired in nature, and communication between the interface and the portable computer 108 may be wired or wireless. As another example, the detectors 101-105 may be configured for direct mounting to the portable computer 108, plugged in using a cable, or fully remotely operated with Bluetooth or an equivalent, allowing the detector(s) to be tossed into a hot zone if needed.

Alarm device 112 may respond to an indicator from the DSP 106, or from the portable computer 108. For instance, if the DSP 106 determines that the incoming signals from the one or more detectors 101-105 exceed a threshold value, the DSP 106 may issue an alarm signal to the alarm 112 via the interface 107. On the other hand, the DSP 106 may not include the comparison functionality, and the portable computer 108 may instead provide this function. For instance, if the DSP 106 merely amplifies and/or converts the analog signals from the detectors 101-105 to a digital signal and forwards that value to the portable computer 108 via the interface 107, the portable computer 108 may be the component to compare the digital signal to a threshold value. If the portable computer 108 determines that the digital signal exceeds the threshold, it will issue an alarm signal to the alarm 112.

The detection threshold levels are adjustable, either automatically or by user input. Instead of fixed alarm points, or thresholds, several are possible, including hard wired and soft (programmed set points or responses). The system 100 can be self-programmed to report continuously or in response to certain stimuli, initiating its own calls or when directed to do so. The alarm 112 “warns” in several ways, such as by producing an audible, visual, and/or sensation alarm. The alarm 112 also “warns” differently depending upon the situation. In the case of increasing radiation levels, the alarm 112 will produce, for instance, two quick vibrational pulses or short beeps. A long beep or vibration signal may signify unsafe radiation levels, and a continuous signal can alarm of a dangerous environment in need of immediate evacuation. Alternatively, the alarm (and potential resulting communications) may be eliminated. Different response scenarios may be activated depending upon whether one or several alarms are activated.

Further, the alarm 112 may be located with the detectors 101-105 and the DSP 106 on the same printed circuit board, so that the alarm function can be provided in the absence of a portable computer 108. Further, the alarm 112 may be a part of the portable computer 112, or a separate alarm can be provided as part of the portable computer 112, such as a visual indicator that shows up on the display of the portable computer 108.

In determining whether to initiate the alarm 112, the portable computer 108 minimizes false positive detections by recording, or obtaining from a data library, a detection profile for the system 100's current location. The system 100 also mitigates false positives by self directing other detection resources to the system 100's current detection location. Such resources may be summoned locally or remotely from a command center.

Also connected to the interface 107 is Global Position System (“GPS”) device 113, which provides the global location of the GPS device 113, and consequently the whole system 100. Such a device provides the precise location of detected radiation or chemical or biological material, and allows for the transmission of the location information to a central command via communication device 109.

Additional power 114, and other options 115, such as extended memory for the portable computer 108, or automobile or AC power adapters, may be provided. Included with other options 115, are a fingerprint identification device and/or a retinal scanner to ensure that only allowed users have access to the system 100. The fingerprint identification device and/or the retinal scanner may be incorporated into the portable computer 108 as well.

Referring now to FIG. 2, a pictorial representation of particular components that may be used with the exemplary embodiment of FIG. 1 are shown. FIG. 2 includes radiological sensors 201, which correspond to 101 in FIG. 1; biological sensors 202, which correspond to 104 in FIG. 1; and chemical sensors 203 which correspond to 105 in FIG. 1. Communicating with the sensors 201-203 is an amplifier, analog to digital converter, and “wake-up” enunciator 204, corresponding to DSP 106 in FIG. 1. An exemplary DSP 204 converts into a 16-bit or greater digital format. In the implementation shown in FIG. 2, the interface 107 is incorporated into PDA 205. Therefore, the DSP 204 communicates directly with the PDA 205. The PDA 205 is an example of a portable computer 108.

As communication means 109-111 of FIG. 1, FIG. 2 shows satellite 206, satellite phone 207, cellular phone 208, modem 209, Bluetooth/WiFi 210, and cradle with USB connection 211. An exemplary satellite telecommunications system 206 and 207 is the Iridium system. As a location determining device, FIG. 2 shows GPS 212, corresponding to 113 in FIG. 1. The GPS 212 should have the highest available position sensitivity and be Geographic Information Systems (“GIS”) compatible. Also shown in FIG. 2 is a booster battery 213, which is an implementation choice for power boost 114. As other options 115, FIG. 2 shows image/video capture 214 that takes images of the location where radiation or chemical or biological material is detected. Image/video capture 214 may also be used for retinal scanning for security purposes or situational awareness communication. Other options 115 include expansion rack 215 for additional devices such as those shown in FIG. 2 (and others yet to be marketed), a radio/CB input 216, auto and AC power adapters 217, and extended memory 218. Further, the system 100 may include a holster 219 to protect the PDA 205 and remote sensor extensions 220 to adjust the location of detection from the sensors 201-203. It should be noted that FIG. 2 is not meant to be an exhaustive list of components for use with the system 100, and are merely examples.

Operation Modes

The system 100 has at least three operation modes: Continuous Mode, Wake/On-Alarm Mode, and On-Demand Mode, all of which may be selected remotely via communications means 109-111. The Continuous Mode is the basic operation mode where the output of the one or more detectors 101-105 is measured in predefined intervals and is transmitted to the portable computer 108. The Continuous Mode also may perform trend analysis and on-board logging of the user's “walking” path if so desired. Due to the continuous operation of this mode, it consumes the most power.

In the Wake/On-Alarm Mode, the activities of the portable computer 108 are triggered by an alarm signal generated by the DSP 106. The signal from the detectors 101-105 is compared with a trigger value using the lowest power electronics. If the user-defined trigger value is exceeded, a trigger, or alarm signal is generated by the DSP 106 and transmitted to the portable computer 108 via interface 107. At this point, the system will “wake-up” and operate in the Continuous Mode to acquire the detector's data and send it out to a predefined destination according to pre-programmed responses. The alarm 112 is also activated to inform the local user(s) of the system 100 of the detection levels. Once informed, the user(s) can reset the system 100 or program the system 100 to perform intermittent measurements until a new threshold is reached in order to conserve power. One of the advantages of this mode is lower power consumption than that of the Continuous Mode. When no alarm is detected, the DSP 106 and portable computer 108 can be put into sleep mode with very little power consumed. The system 100 will run longer without sacrificing measurement functions. In an intermediate power mode, data can be collected in the DSP 106 as a history in certain intervals, and the portable computer 108 can be put into sleep mode between acquisitions. A given detector can also be integrated with onboard memory to accumulate data during sleep modes and such data can be accessed by the portable computer 108 upon waking.

In the On-Demand Mode, the system 100 can be remotely accessed via its integrated cell phone, radio, or satellite phone 109. The requested data will be sent out based on the request. This mode allows the system 100 to be operated from a remote location, such as a central command location, thereby providing a significant degree of operating flexibility.

Exemplary Detectors

Several techniques exist for sensing and monitoring chemical and biological (bacteria, viruses, and toxins) agents. However, most are large, weighty and may require significant sampling times or experience low sensitivity and high false reading rates. Therefore, it is preferable to choose detectors that lend themselves to dramatic size and weight reduction while maintaining sensitivity and simple methods of enhancing agent concentrations to improve sensitivity. Specifically, residual gas analyzers (“RGA”), chemical tape sensors, and infrared (“IR”) spectral absorption instruments where data libraries exist (or can easily be generated), may be used as biological or chemical sensors 104 and 105. A chemical tape sensor is a chemical sensor that includes a reading tape that is spooled in a module. A chemical reaction causes a change in color in the tap, which is read optically for detection purposes. Other detector choices may include certain solid state chemical sensors whose functions can be transferred into meso and micro-scale hardware, whose electronics can be transferred to surface mount compact circuit boards, and whose software can well fit into a PDA platform. Further, MEMS separation type devices or chip scale dye or protein attachment devices are well suited for this application. For primary detectors, it is preferable to have a concentrator wherein high volumes of air are drawn through a cooled matrix in order to absorb the agents of interest along with water vapor from which the agents are periodically desorbed by heating and/or chemically fractured agents into a controlled volume to which the RGA, IR absorption or other measurements can be made and compared to libraries.

Radiation detectors fall into a few categories: gas ionization pulse counters, scintillators, and solid state detectors, usually a positive-intrinsic-negative (“PIN”) device. Because of size and power concerns, gas ionization pulse counters are not a preferred choice. Scintillators, which detect multiple radiation particles, may be used with photomultiplier tubes or PIN photodiodes, depending on several parameters including: price, noise, signal level, and available processing electronics. PIN diodes are used to directly count radiation that directly generates electron hole pairs. These PIN diodes are especially useful for fast triggers for transient high intensity radiation. Exemplary radiation detectors for use with the system 100 are scintillators with photodiodes (and, if necessary, micro-photomultipliers), photodiodes, and a memory cell based detector such as an SRAM radiation detector, such as the one described in U.S. Patent Application entitled “Microelectronic Radiation Detector” by Joseph Cuchiaro and Gary Tompa filed concurrently herewith and previously incorporated herein by reference in its entirety. The SRAM radiation detector outputs a digital signal instead of an analog signal like conventional radiation detectors.

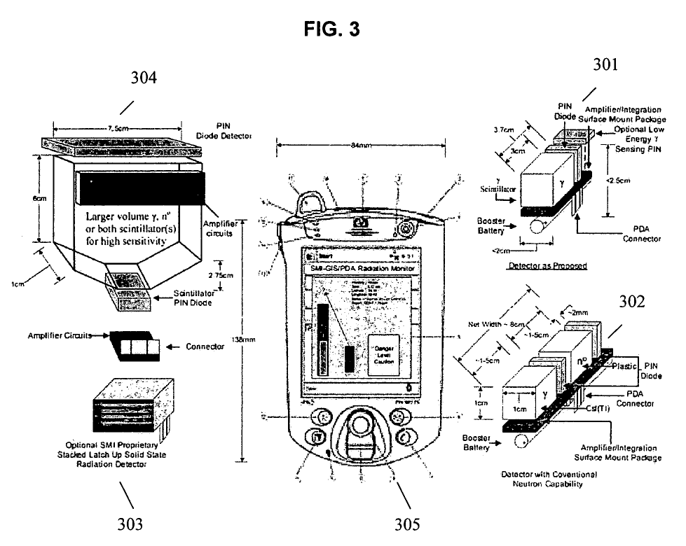

FIG. 3 shows exemplary radiation detectors 101 of the present invention for detecting all types of radiation: alpha, gamma, beta, and neutron. In particular, 301 is a base detector with an extra PIN diode for low energy gamma sensing, 302 is a dual gamma and thermal neutron sensing configuration, 303 is an SRAM radiation detector, and 304 is a large volume/large area scintillator/PIN detector assembly. Detectors 301-304 are merely exemplary choices of radiation detectors that may take the place of detector(s) 101 in FIG. 1 or 201 in FIG. 2. One or more of detectors 301-304 are connected to portable computer 305 as discussed with respect to FIGS. 1 and 2.

The chosen detector(s) may be repackaged into a generic detector module containing the amplifier, analog to digital conversion circuitry, and “wake up” enunciator. The generic detector module is then connected to the portable computer 108. For example, a gamma ray sensitive PIN diode, with scintillator, may be packaged into an approximately 1″×1.5″×1″ module that plugs into a Bluetooth/cellular PDA module multiplexed with a GPS system. In this case, the repackaging includes affixing CsI(Tl) and plastic material to the Si PIN diodes with an inwardly facing configuration with epoxy resin for intimate contact and maximum sensitivity. The package also includes a moisture barrier and the individual components are be baked and dehydrated in a vacuum glove box prior to sealing. An additional PIN diode can be used to sense the low energy gamma radiation.

Exemplary Interface Electronics

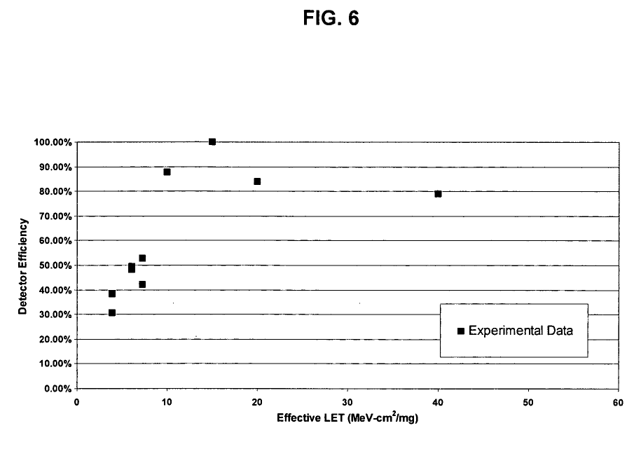

The chosen radiation detectors couple to either PIN photodiodes or photomultipliers. Based upon power, cost, spectrum, and signal intensity, it is best to use photodiodes where possible, while keeping threshold v. noise limit levels acceptable. An example PIN diode “amplifier” package is described in and shown at FIG. 6 of U.S. Pat. No. 5,990,745, issued to Lewis R. Carroll on Nov. 23, 1999, the entire disclosure of which is hereby incorporated herein by reference. Exemplary PIN diodes are from DTL or Hamamatsu, due to their excellent spectral response at 550 nm and high speed signal pulse. If greater sensitivity is desired, a larger scintillator or the micro-photomultiplier of Hamamatsu (R7400-u) may be used.

Exemplary Portable Computer and Accessories

An exemplary computer 108 is the HP iPAQ Pocket PC 5550, which includes a 400 MHz Intel® XScaleTM processor; 128 MB SDRAM; 48 MB Flash ROM; 3.8″ 240×320 16-bit color transflective TFT LCD; a Secure Digital (SD) card slot; SDIO; MMC and PC card support; CF and other iPAQ expansion packs; integrated wireless Bluetooth; WLAN 802.11b (WiFi); a soft keyboard; voice recorder; Microsoft® Pocket PC 2003 Premium; USB desktop cradle/charger; AC adaptor; battery; charger adapter; holster with belt clip; removable/rechargeable lithium-ion polymer battery; and weighs 7.29 ounces.

Exemplary Communications Systems

Regarding cellular phone systems, it is important to note that no cellular system currently provides complete coverage of the United States and all cellular systems are subject to either power failure or capacity overload in an emergency. That said, Code Division Multiple Access (“CDMA”) presently provides the broadest amount of area covered. An exemplary CDMA cellular system is the Growe Corp. model CF2031, which fits into a CF card type II slot and operates in MS Windows pocket PC operating systems. Accordingly, the CF2031 phone can interface directly with the exemplary PDA.

An exemplary satellite phone system is the Iridium system because it has total global coverage, and 14 in-place spare satellites as well as the 66 satellite base systems. The Iridium system also has domestic origins and its phones can connect to the exemplary PDA/detector with a simple interconnect arrangement.

Exemplary GPS

Three categories of GPS systems currently exist for PDA's: (1) a “mouse” type which is connected by cable and is the least desirable because of the need for a cord; (2) a “CF Card” insertable or equivalent module, which is appealing for direct mounting in the exemplary PDA unit; and (3) a Bluetooth version, which is also appealing because it can contain its own power, does not require a slot, and can be placed in a separate “pocket.” Exemplary GPS devices are the Teletype model 1951 having a Bluetooth interface, or the Teletype model 1653 having a CF card interface.

Geographic Information Systems and Joint Mapping Tool Kit

It is preferable that the system 100 complies with the Geographical Information System (“GIS”) format. See http://www.gis.com. With the GIS format, the detected data of system 100 is used to create a map of where radiation (or chemical or biological material) is, the intensity distribution, and the radiation's (or chemical or biological material's) predicted spread and spreading vectors, which can include airborne and aquafier dispersions. As patterns emerge and are tied into other geographical information, such data is used to find a source or plan for short and long term treatments.

It is also preferable to configure the system 100 to mate to the Joint Mapping Tool Kit (“JMTK”) which represents the Mapping, Charting, Geodesy, and Imagery (“MCG&I”) functionality for the Global Command and Control System (“GCCS”) under the Defense Information Infrastructure Common Operating Environment (“DII COE”). See http://pmatccs.monmouth.army.mil/jmtk.html.

Example Implementation

An SRAM device, acting as a radiation detector, and in particular, a linear energy transfer (“LET”) particle detector, was integrated into a PDA interface and tested for detection efficiency using a known radiation beam. The device was tested at the Texas A&M University (“TAMU”) Cyclotron Facility using a broad range of particles. As expected, the detector element run by the PDA was effectively 100% efficient at counting high LET particles. The detector cross-section is plotted versus particle LET and Weibull fitting parameters were extracted to facilitate future modeling efforts to improve the detector efficiency to lower LET particles, particularly the secondary alpha particles from neutron interactions.

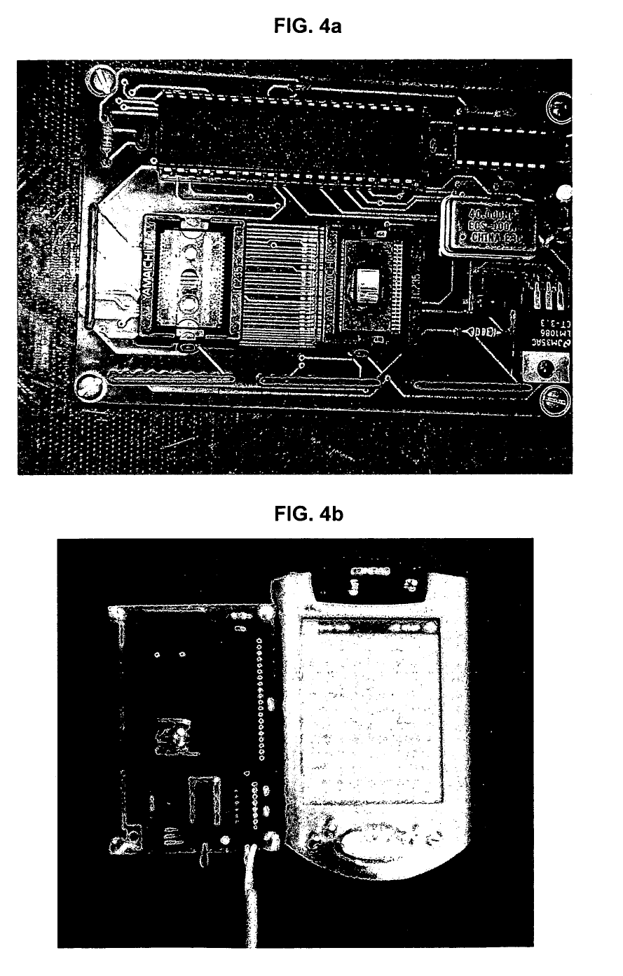

FIG. 4a shows the exemplary detector board. The entire unit is about 3″ by 4″ and weighs a few ounces. The detector element (modified SRAM) is seen mounted in one of the sockets near the center of the board. The total active area of the detector element is only 0.25 cm². This unit is controlled via an RS-232 cable from the PDA (an iPAQ). The RS-232 cable used for this test is about 10-feet long, which allows the user to work and monitor the detector efficiency from the safety of the control room, in this case,f at the TAMU facility.

FIG. 4b shows the prototype detector board alongside the iPAQ PDA. The Americium 241 source is placed directly on top of the SRAM detector element. The PDA reports an error count from the SRAM detector related to the activity of the Americium 241. Americium 241 is a direct alpha particle emitter and serves as a convenient source for demonstration purposes.

During the test, the SRAM detector element was operated in a dynamic mode and was irradiated with a low flux to a low total fluence until a statistically significant number of particles had been detected. The test could not be operated at too low a fluence or flux (1 particle/s or less, for example) or the diagnostic system in the TAMU beam line could not accurately report the ion count. Effectively, the TAMU cyclotron requires a beam flux of approximately 1000 ions/s to maintain proper beam dynamics and diagnostics.

The single event upset (SEU) detector data was collected as follows. First, an initial data pattern was loaded into the memory prior to ion exposure. The patterns were loaded concurrently in the entire memory array and the device was run through several full cycles prior to ion exposure with no errors reported before exposure to the beam to ensure proper operation and that no false errors would be reported. All 8 Mbits of memory were read during this test. Second, the DUT was exposed to a low ion flux intended to produce a small number of errors in the storage cells. Flux was limited as much as possible to be sure not to saturate the detector and possibly mitigate the error count. Third, the detector component was tested over a wide range of LETs while being dynamically read. When an error occurred it was logged and reported back to the PDA. Fourth, the data were logged and plotted to determine the efficiency of the detector element versus ion LET.

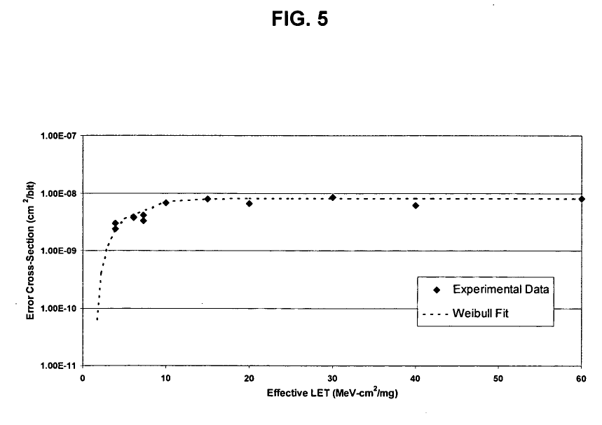

FIG. 5 shows the single-bit detection data recorded at the TAMU facility as error cross-section versus LET. Note that the effective LET of the secondary alpha particles is approximately 2 to 2.5 MeV-cm²/mg. FIG. 6 shows this same data except plotted as detector efficiency versus ELT. The error cross-section is converted into efficiency in this figure by dividing the actual physical area of the active silicon detector. The detector efficiency would be lower if the area of the non-active lead-frame or plastic packaging surrounding the active silicon was considered part of the total area of the detector element.

It is to be understood that the exemplary embodiment is merely illustrative of the present invention and that many variations of the preferred embodiment can be devised by one skilled in the art without departing from the scope of the invention. It is therefore intended that all such variations be included within the scope of the following claims and their equivalents.

What is claimed is:

1. A detection apparatus comprising:
a detector; and
a portable computer communicatively connected to the detector,
wherein the detector transmits a signal to the portable computer when a detection is made by the detector, and the portable computer produces an alarm in response to the signal.

2. The detection apparatus of claim 1 wherein the signal is a detection signal, and the detector comprises (a) a detector element that outputs an unprocessed signal, and (b) a digital signal processing device that converts the unprocessed signal from the detector element into a processed signal, wherein the processed signal is transmitted to the portable computer.

3. The detection apparatus of claim 2,
wherein the digital signal processing device outputs the detection signal if the processed signal is above a threshold level, and
wherein the detector produces its own alarm if the processed signal is above the threshold level.

4. The detection apparatus of claim 3 wherein the threshold level is adjustable.

5. The detection apparatus of claim 1 wherein the detector is selected from the group consisting of a radiation detector, a biometric sensor, a radio frequency sensor, a chemical detector, and a biological detector.

6. The detection apparatus of claim 1 wherein the detector is selected from the group consisting of a scintillator with photodiode detector, a photodiode detector, a memory-cell based radiation detector, a residual gas analyzer (“RGA”), a chemical tape sensor, an infrared (“IR”) spectral absorption instrument, and a solid state chemical sensor.

7. The detection apparatus of claim 6 wherein the memory-cell based radiation detector is an SRAM radiation detector.

8. The detection apparatus of claim 6 further comprising a second detector communicatively connected to the portable computer.

9. The detection apparatus of claim 1 wherein the portable computer is a personal digital assistant (“PDA”).

10. The detection apparatus of claim 1 wherein the portable computer is a laptop computer.

11. The detection apparatus of claim 1 wherein the portable computer is a microprocessor.

12. The detection apparatus of claim 1 further comprising:
a location device communicatively connected to the portable computer.

13. The detection apparatus of claim 12 wherein the location device is a Global Positioning System (“GPS”) device.

14. The detection apparatus of claim 1 further comprising:
a communication device communicatively connected to the portable computer.

15. The detection apparatus of claim 14 wherein the portable computer transmits first information via the communication device.

16. The method of claim 15 wherein the portable computer receives second information via the communication device.

17. The method of claim 16 wherein the first information includes the signal and the second information includes a command.

18. The detection apparatus of claim 14 wherein the communication device communicates via a cellular, Bluetooth, satellite, radio, infrared, WiFi, Universal Serial Bus, parallel, or serial connection.

19. A method of detecting comprising:
generating a detection signal with a detector;
transmitting the detection signal to a portable computer communicatively connected to the detector;
comparing the detection signal to a threshold level; and
producing an alarm signal with the portable computer if the detection signal exceeds the threshold level.

20. The method of claim 19 wherein generating the detection signal comprises converting an unprocessed signal from a detection element into a processed signal with a digital signal processor, and outputting the processed signal as the detection signal.

21. The method of claim 19 further comprising:
transmitting first information via a communication device communicatively connected to the portable computer.

22. The method of claim 21 further comprising:
receiving second information via the communication device communicatively connected to the portable computer.

23. The method of claim 22 wherein the first information includes the alarm signal and the second information includes a command.

24. The method of claim 21 wherein the communication device communicates via a cellular, Bluetooth, satellite, radio, infrared, WiFi, Universal Serial Bus, parallel, or serial connection.

25. The method of claim 22 further comprising:
generating a second detection signal from a second detector;
transmitting the second detection signal to the portable computer communicatively connected to the second detector; and
processing the second detection signal with the portable computer.

26. The method of claim 19 further comprising:
recording a location of the detector with a location device communicatively connected to the portable computer.

27. The method of claim 26 wherein the position location device is a Global Positioning System (“GPS”) device.

28. The method of claim 26 further comprising transmitting the alarm signal and the location of the detector via a communication device communicatively connected to the portable computer.

29. The method of claim 19 wherein the detector is selected from the group consisting of a radiation detector, a biometric sensor, a radio frequency sensor, a chemical detector, and a biological detector.

30. The detection apparatus of claim 29 further comprising a second detector communicatively connected to the portable computer.

31. The method of claim 19 wherein the detector is selected from the group consisting of a scintillator with photodiode detector, a photodiode detector, a memory-cell based radiation detector, a residual gas analyzer (“RGA”), a chemical tape sensor, an infrared (“IR”) spectral absorption instrument, and a solid state chemical sensor.

32. The detection apparatus of claim 31 wherein the memory-cell based radiation detector is an SRAM radiation detector.

33. The detection apparatus of claim 19 wherein the threshold level is adjustable.

34. A method of detecting comprising:
generating a detection signal with a detector; transmitting the detection signal to a portable computer communicatively connected to the detector; analyzing the detection signal; and producing a specified response.
